(19) United States
(12) Patent Application Publication
(10) Pub. No.: US 2005/0117162 A1
(43) Pub. Date: Jun. 2, 2005

(54) Diffractive non-contact laser gauge

(76) Inventors: Bing Zhao, Newton, MA (US); William Budleski, Raleigh, NC (US); Will Middelaer, Simsbury, CT (US); Kenneth Wendt, Higganum, CT (US)

Correspondence Address: CANTOR COLBURN LLP, 55 Griffin Road South, Bloomfield, CT, 06002, US

(21) Appl. No.: 10/955,562

(22) Filed: Sep. 30, 2004

Related U.S. Application Data
(60) Provisional application No. 60/507,340, filed on Sep. 30, 2003.

(51) Int. Cl. G01B 9/02

(52) U.S. Cl. 356/496

(57) ABSTRACT

A non-contact gauge and method of use is provided for optical measurement of an object or objects. The apparatus and methods may comprise a laser providing a projected laser beam; a work-piece holder for holding the object to be measured; a light sensitive sensor located to sense the beam as the beam is diffracted by at least one edge of the object and as the beam forms a near field Fresnel diffraction fringe pattern upon elements of the sensor. The laser and the sensor are located to enable near-field Fresnel diffraction. A fringe pattern signal analyzer may be included for computing mathematical algorithms to determine the position (X₀) of at least one edge of the object based upon the diffraction pattern sensed by the sensor wherein the fringe pattern signal analyzer is structured to refine sensed fringe pattern edge position data to be more accurate based upon a theoretical diffraction compensation factor.

### CROSS-REFERENCE TO RELATED APPLICATIONS

This application claims priority under 35 U.S.C. § 119(e) to provisional U.S. patent application No. 60/507,340 filed Sep. 30, 2003, the entire disclosure of which is hereby incorporated by reference.

### BACKGROUND

The commercial field of non-contact optical dimension gauging has remained fairly constant over the last two decades. The current state of the art uses two primary methods: scanning and projection.

The scanning technique passes a collimated beam over a part, refocusing the beam down to a single photo diode, measuring the time the beam was in the shadow of the part and correlating the shadow time to the part size.

The projection technique measures the size of the shadow cast by a collimated beam whose width is greater than the measured part. Current products using the projection technique make use of CCD's (Charge Coupled Devices), or other electronic capture detectors such as CMOS(Complimentary Metal Oxide Semiconductors) detectors with white or broadband source like LED's (Light Emitting Diode). These products have achieved promising results, although attempts to utilize the projection technique using laser light sources have been less promising. With LED or white light, the edges of the shadow in gray scale are easily locatable using current edge detection techniques in the digital image-processing domain. It is widely recognized that current digital signal processing techniques can locate an edge within 0.1 pixel precision through reading gray scale information. Commercial products with broadband light source use collimating systems, as it is not easy to make a small size point source that is bright enough for projection systems. The projection technique is usually embodied in a system using a collimating lens to allow for the measurement of objects up to the size of the lens. However, using lasers as expanded beam light sources in this type of collimated/projection system has been impractical given the difficulty in precisely locating the edge with better than 1 pixel precision due to the what was attributed to signal noise, signal instability and difficulties in achieving uniform illumination in commercial products.

It is also generally the case that non-contact measurement using diffraction typically relies on the far-field or Fraunhofer diffraction principles in a markedly different scheme than near field Fresnel diffraction.

Applicant notes two U.S. patents which are related to Fresnel diffraction and to diameter measurement.

The first is U.S. Pat. No. 5,015,867 entitled “Apparatus and methods for measuring the diameter of a moving elongated material” which proposes a non-contact gage for fiber diameter measurement. Several laser-CCD devices were used to obtain Fresnel diffraction and interferometry information. The interferometry comes from the interference of two diffracted beams as the fiber diameter is small. By comparing the tested signal with a theoretical Fresnel diffraction pattern and by using interferometry, the diameter of the fiber and the diameter variation in the fiber can be determined.

The second patent, U.S. Pat. No. 4,880,991, proposes a non-contact gauge for in-process measuring of a work-piece diameter. The disclosure includes three sets of laser-CCD devices to determine the positions of three points in the work-piece. The three points are located by identifying the tangent points of the Fresnel diffraction fringe pattern. The common features of these two patents are that multiple laser-CCD devices are used and original, non-expanded, laser beams are used.

The prior art has several disadvantages. For example, the edge diffraction effect is generally not taken into account or used in current commercial length measurement gauges, in which the edge is determined by using empirical digital signal (image) processing techniques. In contrast, edge diffraction theory has a stronger basis in physics than the edge detection algorithms used in digital signal (image) processing techniques. For example, these prior art techniques may provide incorrect results, i.e., for the diffraction of a straight edge, a zero-cross point determined from the diffracted signal may be far from the real edge.

Furthermore, known algorithms for edge detection used in gray scale signal processing techniques only use information local to the edge, i.e., a few to several pixels worth of data. Thus, it would be more desirable to use an edge diffraction method that could make it possible to use the whole diffraction field data which may be about several hundred pixels per edge, spread over several millimeters.

Thus overall in the prior art, in both projection and scanning techniques, the edge diffraction effect is either neglected or decreased.

Thus, there is a need to use Fresnel edge diffraction phenomenon with laser light sources to obtain more accurate measurements of workpieces being measured, especially for work-pieces having rough surfaces.

Additionally, there is a need to measure more than length or diameter of a turned part. It would be desirable to measure many dimensions at once such as diameter, length/height, width, curvature, and distance/displacement from the detector.

There is also a need to use different light sources other than directly using a laser beam as a collimating beam source. For example, there is a need in the art to simplify the systems to use an expanded laser beam, i.e., a structured beam with fan angle, or an expanded laser collimated beam. Use of an expanded beam will make a system simple and flexible, and will allow the measurement of a wider range of object sizes.

Additionally, non-contact gauging systems generally require complex data processing approaches. Therefore, there is a need to improve the data processing for example by digital or analog methods.

There is also a need to simplify system configurations and components. The prior art patent references above, for example, both use multiple laser-CCD devices. Therefore, there is a need to simplify measurement systems by reducing components and by making the systems more compact.

Additionally, there is a need for measurement capability that includes roughness and thickness of step-shape work-piece for length or height measurement. For example, the two patents discussed above deal only with diameter or curvature of a uniformly shaped object.

### SUMMARY OF THE INVENTION

In accordance with the teachings of the present invention, an apparatus may be provided for non-contact optical measurement of an object or objects. The apparatus may comprise a laser providing a projected laser beam; a work-piece holder for holding the object to be measured; a light sensitive sensor located to sense the beam as the beam is diffracted by at least one edge of the object and as the beam forms a near field Fresnel diffraction fringe pattern upon elements of the sensor wherein the laser and the sensor are located to enable near-field Fresnel diffraction; and a fringe pattern signal analyzer for computing mathematical algorithms to determine the position (X₀) of at least one edge of the object based upon the near field Fresnel diffraction pattern sensed by the sensor wherein the fringe pattern signal analyzer is structured to refine sensed fringe pattern edge position data based upon a theoretical diffraction compensation factor.

In accordance with the teachings of the present invention, a method may be performed for non-contact optical measurement of an object comprising projecting a laser beam upon the object to be measured; diffracting the beam around at least one edge of the object; sensing the beam via a light sensitive sensor as the beam is diffracted by the at least one edge of the object and as the beam forms a near field Fresnel diffraction fringe pattern upon elements of the sensor wherein the laser and the sensor are located to enable near-field Fresnel diffraction; and determining at least one edge position via a fringe pattern signal analyzer by computing mathematical algorithms to determine the position of at least one edge (X₀) of the object based upon the near field Fresnel diffraction pattern sensed by the sensor wherein the fringe pattern signal analyzer additionally performs a refinement of sensed fringe pattern position data based upon a theoretical diffraction compensation factor.

Additionally, in accordance with the teachings of the present invention, a device may be provided for measuring an object comprising a projected laser beam light source; and a light sensitive Fresnel-near field diffractive sensor structured to solve mathematical algorithms to measure an object based upon at least one sensed edge position of the object indicated from at least one sensed Fresnel-near field diffractive pattern which the object casts upon the sensor from the projected laser beam.

### BRIEF DESCRIPTION OF THE FIGURES

The following descriptions should not be interpreted to be limiting of the invention in any manner.

FIG. 1 is a conceptual diagram of an embodiment of an apparatus made in accordance with the teachings of the present invention.

FIG. 2 is a diagram of a Fresnel diffraction fringe pattern.

FIG. 3 is a flow chart of a method in accordance with the teachings of a first signal processing algorithm.

FIG. 4 is a flow chart of a method in accordance with the teachings of a second signal processing algorithm.

FIG. 5 is a flow chart of a method in accordance with the teachings of a third signal processing algorithm.

FIG. 6 is a diagram showing expanded and collimated laser beams.

### DETAILED DESCRIPTION OF THE PREFERRED EMBODIMENTS

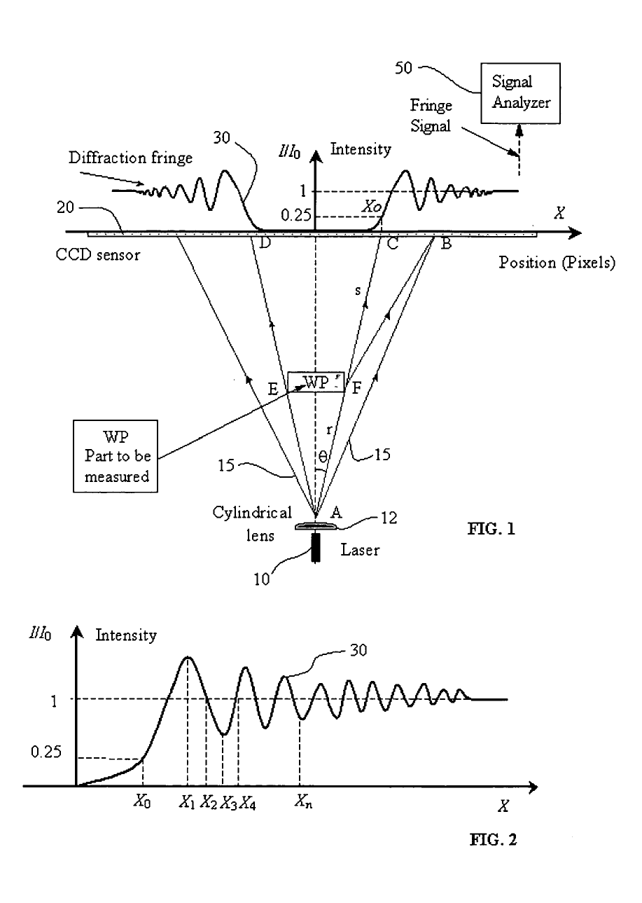

Referring to FIG. 1, a preferred embodiment of the present invention is shown which relates to a non-contact dimensional gauge and method for dimension measurement such as for part diameter, length, and distance from the sensor array, and for on-line inspecting such as work-piece positioning, work-piece motion, and work-piece size changing. The apparatus shown in FIG. 1 may be termed a “gauge” and may comprise a laser 10 based light source arranged to produce an expanded laser beam 15, a linear multi-element array detector 20, and a signal-processing analyzer 50 comprised of standard hardware and/or software.

Prior art apparatus and methods do not improve or refine the sensed sensor array data by using the detailed information derivable from Fresnel near field diffraction and interference theory. As stated in the Background above, broadband light sources with gray scale solutions are commonly used instead. Significantly, the preferred embodiment uses Fresnel near-field structural arrangements and theoretically based methods and algorithms to refine the information present in the resultant Fresnel edge diffraction pattern using laser light (See diffraction fringe 30). The diffraction fringe 30 is created by the projected laser light being interrupted by the work-piece WP. The edges (E, F) of the work-piece WV are located and measured much more accurately, i.e., to sub-pixel accuracy by using the structures and methods in accordance with the teachings of the present invention than if the pixel size (and spacing) of the capture device were used alone. Other measurands such as the distance “s” between the capture or sensor device 20 and the work-piece WV), the diameter of the workpiece WP, and the length of the workpiece WI) can also be accurately determined from the diffraction fringe 30 using the structure and methods of the present invention. Three preferred methods of Fresnel diffraction signal processing may be used to refine and to determine the information of size and location of the work-piece and are specifically discussed below. However other variants are also envisioned. These three signal processing methods may be used alone or in combination.

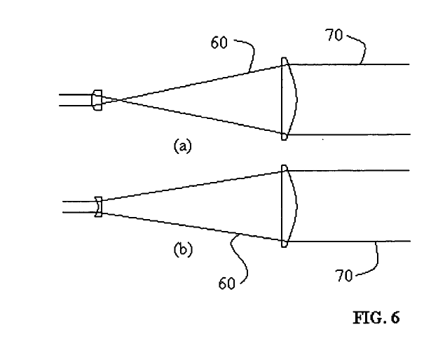

As seen in FIG. 1, in the preferred embodiment, the measurement system consists of a laser 10, a linear multi-element sensor 20, a work piece holder (not shown) structure for holding the artifact or workpiece WP to be measured, and beam expanding lens 12 which in this case is a cylindrical lens. Note that the beam 15 is expanded in this embodiment to be larger than the object being measured, i.e., the width of the beam 15 is expanded to have a fan angle larger than the workpiece, WP. This allows objects larger than the original unexpanded beam to be measured with one incident beam. See also FIG. 6 for a diagram of laser beam expanders and expanded laser beams generally. It is noted herein that use of a collimated beam or an expanded collimated beam is also possible as an alternative embodiment with the remaining structures being substantially the same. See FIG. 6 for examples of an expanded beam 60 and a collimated beam 70. Also, it is noted that if a structured laser line with a fan angle is used then a beam-collimating system is not necessary. Also, an embodiment may also include the capability to sense a plurality of edge positions within a single beam width of the projected laser beam light source. An embodiment may also incorporate a spherical lens beam expander wherein the beam is propagated through the spherical lens beam expander and a collimator lens wherein the beam is propagated through the collimator lens so that the beam is diffracted by at least one edge of the object and so that the beam forms a near field Fresnel diffraction fringe pattern upon multi-axis elements of the sensor for multi-axis measurement of the workpiece.

As the diffraction fringe pattern 30 needs to last for only several millimeters, diode lasers are preferable as a light source. Further, diode lasers are preferred due to their compact size, small power requirement and low heat generation. Broadband sources such as LED's and white light cannot supply sufficient coherence length to obtain a sufficient diffraction pattern to be useful for edge location. For example, the coherence of a white light source is only about 2-3 microns. Regarding the linear multi-element sensor 20, a linear CCD with several thousand pixels is suitable for the gauge or apparatus of the preferred embodiment, although other sensors may be used. For example, a CCD line array with 10680 separate addressable pixel elements may be used with pixel widths of 4-14 μm. A multi-axis (x,y) CCD sensor may also be used for multi-axis measurement and for profiling multi-shaped parts with multiple edges for example.

As shown in FIG. 1, in the preferred embodiment, a length measurement is performed with laser 10, cylindrical lens 12, expanded laser beam 15, and a CCD sensor array serving as the linear multi-element sensor 20. FB is the diffracted beam diffracted from an edge F of the work-piece WP which is held in place by a work-piece holder (not shown). When beam FB meets the directly impingent beam AB, interference will occur at point B. In FIG. 1, the dimensionless intensity (I/I₀) of the diffraction fringe signal is also shown.

From the diffraction fringe signal 30, in the preferred embodiment, the points on the sensor array 20 representing the edge points of the work-piece, C and D, are sensed to sub-pixel precision that may include use of the entire diffraction field and by use of the signal analyzer 50. The signal analyzer 50 may be a signal processor, a standard personal computer, or software. The signal analyzer 50 performs a refinement based on diffraction and interference theory regarding the resultant sensed edge position X₀ data by running at least one of the algorithms 1-3, discussed in detail below and as shown in the figures. These algorithms use diffraction theory to provide what is termed herein a “theoretical diffraction compensation factor.” Also, it is possible to directly measure the distance between C and D, that is the length of the shadow of the workpiece WP from edge E to edge F, and that was projected onto the CCD sensor plane. The distances CF and CA can also be determined geometrically, as well as the angle θ, and the diameter and length of the workpiece by using the diffraction fringe signal 30. This is similar to a triangulation method. It is also emphasized that the present invention may also measure the distance “s” from the workpiece WP to the linear sensor plane even when a collimating beam is used. Thus, the preferred embodiment has the advantage that it allows several measurands to be measured. This is in contrast to the prior art which only measures the diameter and the curvature of a spherical part. The present invention may measure a number of additional measurands such as length, height, diameter, and distance of the object from the sensor array and distance from the light source. Square, rectangular, stepped, ball-shaped, and other shaped objects as well as rough surfaced parts, wires, and cables are also measurable according to the teachings of the present invention. These shapes are examples, and the invention is not limited to measurement of only these shapes. This is accomplished with minimal light source and sensor hardware, for example one laser and one CCD sensor may be used which have no moving parts in contrast to many more complex and more expensive scanning method devices.

In the preferred embodiment, a CCD line scan camera having 7 μm×7 μm pixels and an 8-bit output for each pixel is used to measure cylinders up to 1 inch in diameter. In a gauge of this type, precision is a function of pixel size, pixel sensitivity, and signal processing algorithms. Our gauge reduces the requirement for smaller and more sensitive pixels by using signal processing algorithms that increase precision. Significantly, the signal processing is also simplified due to the use of the accuracy and precision increasing algorithms discussed below. Thus overall, accurate, simple, and cost effective devices and methods for optical measurement of parts including opaque parts may be provided.

Fresnel Edge Diffraction

Diffraction phenomenon can be observed when a light beam illuminates a barrier. Optical field distribution, i.e., the intensity and beam propagation direction, beyond the barrier is changed from that of the incident field. Diffraction phenomenon can be explained and exploited based upon the electromagnetic wave equation. A rigorous solution of the wave equation for most situations is difficult to obtain. If polarization effects could be neglected, scalar diffraction theory, for example, Huygens' principle can be shown to be an excellent approximation to the behavior of the solution to the wave equation. Based on Huygens' principle, the Fresnel-Kirchhoff integral formula is derived to quantitatively describe the diffraction phenomenon. For the case where the light source and observation points are far from the barrier, called far-field or Fraunhofer diffraction, a linear approximation can be made to obtain the solution of Fresnel-Kirchhoff integral. As to near-field or Fresnel diffraction, the exact solution of Fresnel-Kirchhoff integral is difficult to determine, except for some special cases. The diffraction of a straight edge is among these special cases.

The diffraction model used is the semi-infinite opaque screen diffraction model. When this model is used for a thick part such as cylinder measurement, error occurs. For example, for a large diameter cylinder of 0.5 inch or more, the measured diameter is about 1% larger than its actual size. This error can be corrected by calibration. There are models for cylinder and step edge diffraction (see P. L. Marston, “Selected papers on geometrical aspects of scattering,” SPIE Milestone Series, Vol. MS89, SPIE Optical Engineering Press, Bellingham, 1994 and see M. T. Tavassoly, H. Sahlol-bai, M. Salehi, H. R. Khalesifard, “Fresnel diffraction from a step in reflection and transmission models,” Proceeding of SPIE, Vol. 3749, pp.560-561, 1999). However, these models are not practical for use in engineering.

The recorded intensity of the Fresnel fringe pattern can be expressed by (see M. Born, E. Wolf, “Principles of Optics,” Pergamon Press, third edition, New York, 1965)
I=0.5{[0.5+C(w)]²+[0.5+S(w)]² }I₀
where I₀ is the original beam intensity distribution without the work-piece interrupting the beam. The Fresnel integrals C and S are

$$\{ \begin{matrix}C ( w ) = {\int }_{0}^{w} cos ( 0.5 π {t}^{2} ) ⅆ t \\ S ( w ) = {\int }_{0}^{w} sin ( 0.5 π {t}^{2} ) ⅆ t\end{matrix}$$

The dimensionless parameter w is given by

$$w = \sqrt{\frac{2 r}{λ s ( r + s )}} X cos θ$$

where r and s are distances to the workpiece and from the workpiece to the sensor, respectively, and θ is the angle as shown in FIG. 1. From r and s the diameter or height of the workpiece WI may also be found depending upon how the object is orientated. When a collimating beam is used, length AC will be vertical to the CCD sensor plane and workpiece WI with edges EF; thus, the above expression can be further simplified as:

$$w = \sqrt{\frac{2}{λ s}} X$$

The above equation clearly expresses that the shape of the fringe signal, mainly the period distribution, is only determined by the distances “s” from the workpiece WI) to the linear array in the collimating beam case. Thus, no relationship with the length of the workpiece shown as EF, and the horizontal position is needed for the equation. This will facilitate the signal processing work in the case where a collimated beam is used.

The preferred Fresnel near field diffraction methods in accordance with the present invention which are used to interpret the fringe pattern are discussed below. One or all these method may be used alone or in combination.

For a non-contact gauge, signal processing is typically a large and complex task. In the present invention, three preferred methods, each also termed herein as a “theoretical diffraction compensation factor,” may be used to process the Fresnel near field fringe pattern depending upon the desired application and processing requirements in a more simple and more accurate and precise manner than is known in the prior art.

Signal Processing Technique I

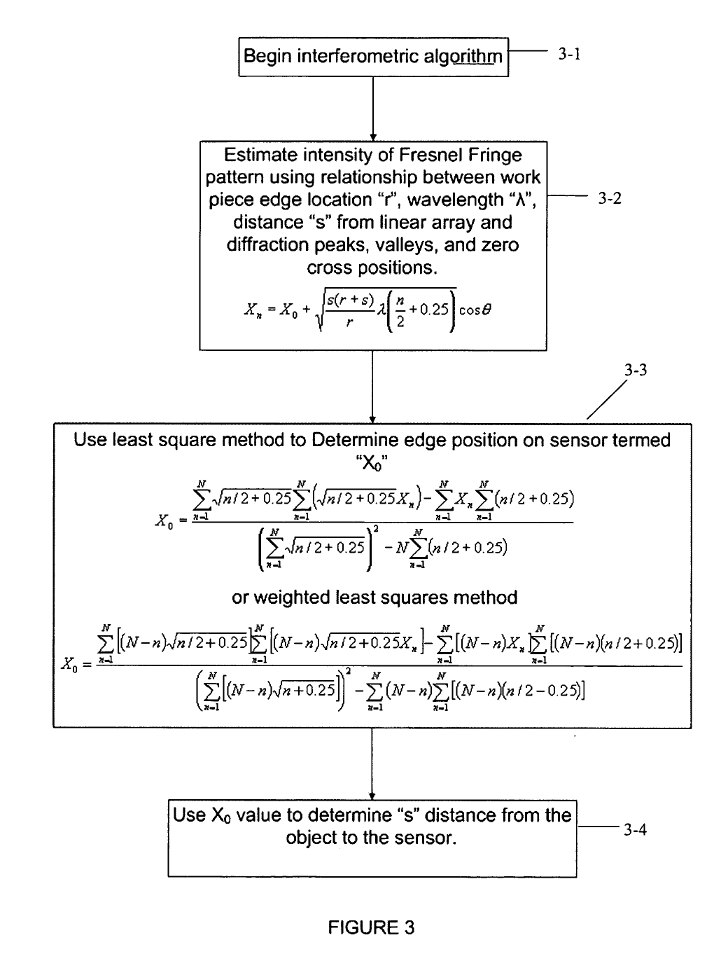

The first method, hereinafter known as the “interferometric algorithm” which uses the peak, valley, and zero-cross positions to process and refine the signal from the CCD array, can be briefly described as follows and is shown generally in FIG. 3. In FIGS. 1 and 2, Fresnel diffraction fringe structures 30 are shown, where X₀ is an edge position. X₁, X₅, X₉, . . . represent peak positions, X₂, X₄, X₆, . . . represent zero cross points, and X₃, X₇, X₁₁, . . . represent valley positions. An interpretation of interferometry theory is used as a refinement and as a compensation factor to give an approximate but practical expression for the intensity distribution of the near field Fresnel edge diffraction. This is termed herein as a “theoretical diffraction compensation factor.” In the present method, the for the group L or X_{L}, of the peak, valley, and zero-cross positions are given as

$${X}_{n} = {X}_{0} + \sqrt{\frac{s ( r + s )}{r} λ ( \frac{n}{2} + 0.25 )} cos θ$$

where n=1, 3, 5, . . . for zero-cross points, 2, 6, 10, . . . for peaks and n=4, 8, 12, . . . for valleys (See Ref. Nums. 3-1, 3-2). Using these theoretical peak, valley, and zero-cross positions and the recorded peak and valley position values, the present method can more accurately determine edge position, X₀, in the signal analyzer 50 in comparison to the unprocessed signal. A least square method is utilized to determine the resultant data. For example, generally:

$${X}_{0} = \frac{\begin{matrix}{\sum }_{n = 1}^{N} \sqrt{n / 2 + 0.25} {\sum }_{n = 1}^{N} ( \sqrt{n / 2 + 0.25} {X}_{n} ) - \\ {\sum }_{n = 1}^{N} {X}_{n} {\sum }_{n = 1}^{N} ( n / 2 + 0.25 )\end{matrix}}{{( {\sum }_{n = 1}^{N} \sqrt{n / 2 + 0.25} )}^{2} - N {\sum }_{n = 1}^{N} ( n / 2 + 0.25 )}$$

where Nis the total number of peak, valley, and zero-cross position values used (See Ref. Num. 3-3).

Specifically, for example, N could be 100, i.e., 25 peaks and 25 valleys, and 50 zero-cross points. In that case, the following weighted least square method may be employed:

$${X}_{0} = \frac{\begin{matrix}{\sum }_{n = 1}^{N} [ ( N - n ) \sqrt{n / 2 + 0.25} ] {\sum }_{n = 1}^{N} [ ( N - n ) \sqrt{n / 2 + 0.25} {X}_{n} ] - \\ {\sum }_{n = 1}^{N} [ ( N - n ) {X}_{n} ] {\sum }_{n = 1}^{N} [ ( N - n ) ( n / 2 + 0.25 ) ]\end{matrix}}{\begin{matrix}{( {\sum }_{n = 1}^{N} [ ( N - n ) \sqrt{n + 0.25} ] )}^{2} - \\ {\sum }_{n = 1}^{N} ( N - n ) {\sum }_{n = 1}^{N} [ ( N - n ) ( n / 2 - 0.25 ) ]\end{matrix}}$$

The resultant edge location X₀ that is determined is thus more accurate than a determination of X₀ from the unprocessed signal alone. X₀ may be used to determine the distance “s” which is the distance from the work-piece WP to the sensor 20 for example (See Ref. Num. 3-4 and FIG. 1).
Signal Processing Technique II

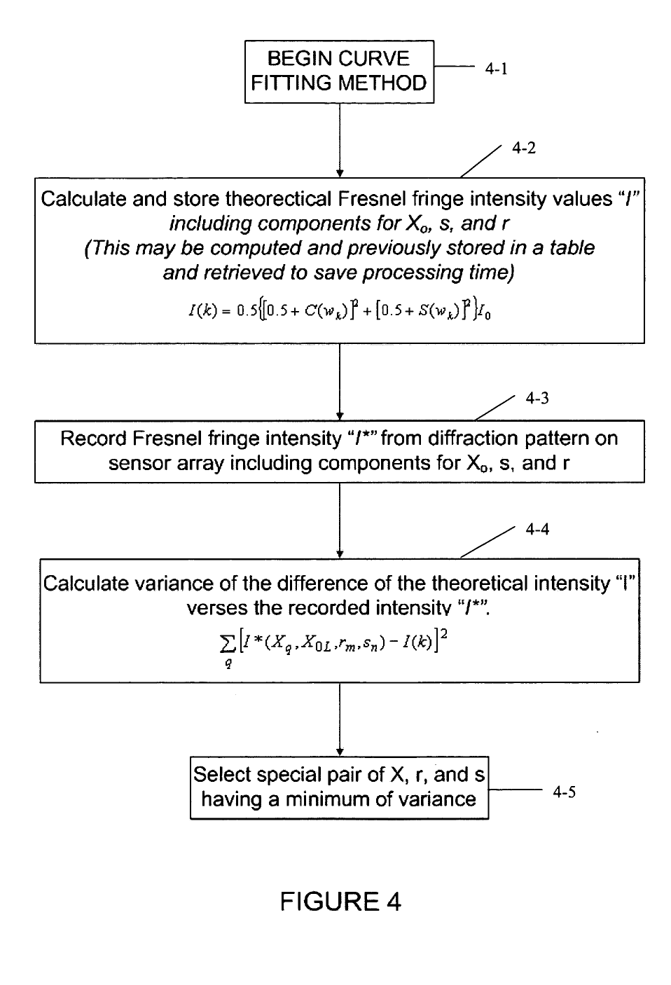

The second preferred signal processing method or algorithm is termed the “curve-fitting method” and is shown generally in FIG. 4 (See Ref. Nums. 4-1-4-5) and is also termed herein a “theoretical diffraction compensation factor.” The algorithm relies on comparing the tested and recorded fringe signal directly with the theoretic signal of near field Fresnel diffraction using the straight edge model. The theoretical values of Fresnel fringe intensity is pre-calculated and stored to save processing time. The discrete intensity values are calculated from:
I(k)=0.5{[0.5+C(wₖ)]²+[0.5+S(wₖ)]²]I₀
Where k=1, 2, 3, . . . (See Ref. Num. 4-2). K is index for the discrete intensity I. I is stored like a 1-D table as a function of k. K, maximum k, could be in order of 10⁴ or 10⁵. w varies as
wₖ=20(k−1)/K

Given a group of X₀, s and r (defined previously and shown in FIGS. 1, 2, see also Ref. Num. 4-3), i.e., X_{0L} and rₘ and sₙ (L=1, 2, 3, . . . ; m=1, 2, 3, . . . ; n=1, 2, 3, . . . ), the task is now to determine which X_{0L}, rₘ and sₙ pair is the right one to accurately indicate edge position. For each fixed X_{0L}, rₘ and sₙ, we can calculate the index k by

$$k = \frac{K}{20} \sqrt{\frac{2 {r}_{m}}{λ {s}_{n} ( {r}_{m} + {s}_{n} )}} ( {X}_{q} - {X}_{0} ) cos θ + 1$$

where q is the pixel coordinate. Knowing k, theoretical diffraction intensity distribution can be easily obtained from the stored file. Then, we calculate the variance of the difference of the theoretic intensity I and recorded intensity I*, i.e.,

$${\sum }_{q} {[ {I}^{*} ( {X}_{q} , {X}_{0 L} , {r}_{m} , {s}_{n} ) - I ( k ) ]}^{2} \qquad ( See Ref . Num . 4 \text{-} 4 ) .$$

The variances are calculated for the whole group Of X_{0L} and rₘ and sₙ. Among this group, only one special pair Of X_{0L} and rₘ and sₙ which has the variance minimum is selected (See Ref. Num. 4-5).
Signal Processing Technique III

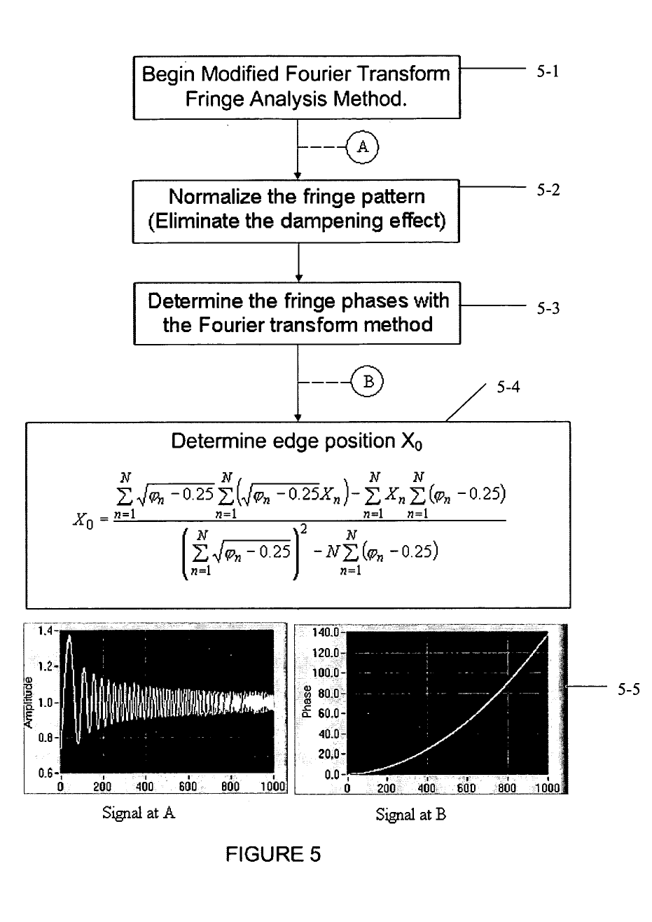

The third method as shown generally in FIG. 5, is termed the “modified Fourier transform fringe analysis method.” This method is also termed herein a “theoretical diffraction compensation factor.” The previous two methods discussed above use fringe intensity information to determine the measurands, so they may be classified as intensity methods. Signal processing technique “I” may also be defined as a phase method, i.e., using fringe phase information to determine the measurands, where only the phase information at fringe peaks, valleys and zero-cross points are used in that method.

The exact expression of Fresnel diffraction fringe pattern can be found in some references (for example, R. W., Boyd, D. T. Moore, “Interferometric measurement of the optical phase distribution for Fresnel diffraction by a straightedge,” Applied Optics, Vol.18, No. 12, pp2013-2016, 1979). However, these expressions are difficult to use in instrument development. In our Fresnel near field diffraction case, we simplify the diffraction fringe pattern as sinusoidal fringes multiplied with a damping factor. In the present method, the relationship between fringe phase and the edge position can be estimated by

$${φ}_{x} = [ \frac{{( X - {X}_{0} )}^{2}}{λ} ( \frac{r}{s ( r + s )} ) cos θ + 0.25 ] π$$

This expression precisely predicts the positions of fringe peak, valley, and zero-cross points. Now knowing the phase values φ_{X} at X (See Ref. Num. 5-5 and the Signal at B), we can precisely determine the edge location X₀. We rewrite the above equation in a discrete form:
Xₙ=X₀+Y_{c}\sqrt{φₙ−0.25π}
where n=1, 2, 3, . . . , N, N is the total number of pixels, Y_{c} is a constant determined by wavelength λ, and geometric parameters such as r, s, and θ. Given the above, we determine X₀ with the following formula (See Ref. Num. 5-4):

$${X}_{0} = \frac{{\sum }_{n = 1}^{N} \sqrt{{φ}_{n} - 0.25} {\sum }_{n = 1}^{N} ( \sqrt{{φ}_{n} - 0.25} {X}_{n} ) - {\sum }_{n = 1}^{N} {X}_{n} {\sum }_{n = 1}^{N} ( {φ}_{n} - 0.25 )}{{( {\sum }_{n = 1}^{N} \sqrt{{φ}_{n} - 0.25} )}^{2} - N {\sum }_{n = 1}^{N} ( {φ}_{n} - 0.25 )}$$

This method is particularly suited to use the whole diffraction field data which may be for example about several hundred pixels per edge, spread over several millimeters.

FIGS. 1 and 2 also illustrate the intensity damping of the diffraction fringe pattern. This damping can be approximately expressed with a coefficient exp(aX²+bX+c). At the edge, i.e., X=X₀, the damping coefficient is equal to 1. It decreases rapidly to zero as X increases several millimeters from edge. In order to use the Fourier transform method, the damping effect must be eliminated. This is realized by dividing the fringe intensity by the damping coefficient (See Ref. Nums. 5-1-5-3). Fourier transform fringe analysis technique can be found in many publications (See B. Zhao, A. Asundi, “Discussion on spatial resolution and sensitivity of Fourier transform fringe detection,” Optical Engineering, Vol. 39, No. 10, 2000, pp. 2715-2719 and see B. V. Dorrio, J. L. Fernandez, “Phase-evaluation methods in whole-field optical measurement techniques,” Measurement Science and Technology, Vol. 10, 1999, pp. R33-R55 or other documents listed in these two papers).

The first method is precise and easily realized, but the second is less computationally intense, allowing for faster processing. These two methods can be combined together to form an overall theoretical diffraction compensation factor, i.e., first the second method is used to determine the initial values of edge X₀, then the first method is used to refine it. This saves considerable processing time. The third method provides precisely measured results, but it is also more sensitive to fringe signal quality.

Thus, in accordance with the teachings of the present invention, the principles of diffraction may be combined with a sensor or multi-sensor array to locate points in three dimensions with great precision. This is useful for measurement as well as process control, as the present invention may provide not only the diameter and length, but also the distance of the edges from the sensor. An embodiment of the present invention can accomplish this without necessitating moving parts, and can determine the location of an edge or multiple edges. Further, when more than one edge is detected, the distance between two edges of an artifact, such as diameter may be computed. In accordance with the teachings of the present invention, the apparatus and methods can determine not only the diameter or length of an artifact, but also how far away it is from the sensor array.

While the invention has been described with reference to exemplary embodiments, it will be understood by those skilled in the art that various changes may be made and equivalents may be substituted for elements thereof without departing from the scope of the invention. Terms such as “first” and “second” are used herein merely to distinguish between methods and structures, and are not intended to imply an order such of importance or location. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for non-contact optical measurement of an object comprising:
a laser providing a projected laser beam;
a workpiece holder for holding the object to be measured;
a light sensitive sensor located to sense the beam as the beam is diffracted by at least one edge of the object and as the beam forms a near field Fresnel diffraction fringe pattern upon elements of the sensor wherein the laser and the sensor are located to enable near-field Fresnel diffraction; and
a fringe pattern signal analyzer for computing mathematical algorithms to determine the position (X₀) of at least one edge of the object based upon the near field Fresnel diffraction pattern sensed by the sensor wherein the fringe pattern signal analyzer is structured to refine sensed fringe pattern edge position data based upon a theoretical diffraction compensation factor.

2. The apparatus of claim 1 wherein the laser is a single laser.

3. The apparatus of claim 1 wherein the light sensitive sensor is a single charge coupled device (CCD) linear sensor.

4. The apparatus of claim 1 further comprising a beam expander wherein the laser beam is propagated through the beam expander to become a line structured beam with a fan angle.

5. The apparatus of claim 1 further comprising a beam collimator wherein the laser beam is propagated through the beam collimator and is thereby formed into a collimated laser beam.

6. The apparatus of claim 1 further comprising a beam expander and collimator wherein the laser beam is propagated through the beam expander and the collimator and becomes an expanded collimated laser beam.

7. The apparatus of claim 1 wherein the apparatus is structured to have no moving parts.

8. The apparatus of claim 1 wherein the light sensitive sensor is structured to sense an entire diffraction field.

9. The apparatus of claim 4 wherein beam expander is structured so that the beam width is expanded by the beam expander to be greater than the area of the object to be measured in order to diffract the beam at all of the edges of the object with the beam.

10. The apparatus of claim 4 wherein the beam expander is a cylindrical lens.

11. The apparatus of claim 1 wherein the theoretical diffraction compensation factor is based on a first algorithm that uses diffraction fringe peaks, valleys, and zero cross points as data points to approximate the intensity distribution of the near field Fresnel diffraction fringe pattern.

12. The apparatus of claim 1 wherein the theoretical diffraction compensation factor is based on a second algorithm that calculates variance between a theoretical intensity (I) and a recorded intensity (I*) and selects a special pair of minimum variant components as the edge position.

13. The apparatus of claim 1 wherein the theoretical diffraction compensation factor is based on a third algorithm that determines a relationship between fringe phase and edge position using a total number of pixels in the entire fringe pattern, wavelength of the beam, geometric parameters of the beam, and which also eliminates a fringe dampening effect and performs a Fourier transform.

14. A method for non-contact optical measurement of an object comprising:
projecting a laser beam upon the object to be measured;
diffracting the beam around at least one edge of the object by near-field Fresnel diffraction;
sensing the beam via a light sensitive sensor as the beam is diffracted by the at least one edge of the object and as the beam forms a near field Fresnel diffraction fringe pattern upon elements of the sensor wherein the laser and the sensor are located to enable near-field Fresnel diffraction; and
determining at least one edge position (X₀) via a fringe pattern signal analyzer by computing mathematical algorithms to determine the position of at least one edge of the object based upon the near field Fresnel diffraction pattern sensed by the sensor wherein the determining includes performing a refinement of sensed fringe pattern position data based upon a theoretical diffraction compensation factor.

15. The method of claim 14 wherein the theoretical diffraction compensation factor is based on a first algorithm that uses estimated locations of diffraction fringe peaks, valleys, and zero cross points as data points to approximate the intensity distribution of the near field Fresnel diffraction fringe pattern.

16. The method of claim 15 wherein the first algorithm uses the following relation to estimate the locations Xₙ of n diffraction peaks, alleys, and cross positions,
$${X}_{n} = {X}_{0} + \sqrt{\frac{s ( r + s )}{r} λ ( \frac{n}{2} + 0.25 )} cos θ$$
where n=1,3,5 . . . for zero cross point positions, n=2, 6, 10 . . . for peak positions, and n=4, 8, 12 for valley positions and wherein the method uses a least square method to determine X₀.

17. The method of claim 14 wherein the theoretical diffraction compensation factor is based on a second algorithm that calculates variance between a theoretical intensity (I) and a recorded intensity (I*) and selects a special pair of minimum variant components as the edge position.

18. The method of claim 17 wherein the second algorithm uses the following relation:
$${\sum }_{q} {[ I * ( {X}_{q} , {X}_{OL} , {r}_{m} , {s}_{n} ) - I ( k ) ]}^{2}$$
where k is an index of theoretical fringe intensity I, I* is the recorded fringe intensity, q is pixel position, X₀ is edge position, r is the distance to the object being measured from the light source, and s is the distance from the object to the sensor.

19. The method of claim 14 wherein the theoretical diffraction compensation factor is based on a third algorithm that determines a relationship between fringe phase and edge position using a total number of pixels in the fringe pattern, wavelength of the beam, geometric parameters of the beam, and which also eliminates a fringe dampening effect and performs a Fourier transform.

20. The method of claim 19 wherein the third algorithm uses the relations:
Xₙ=X₀+Y_{c}\sqrt{φₙ−0.25π}
where n=1, 2, 3, . . . , N, N is the total number of pixels, Y_{c} is a constant determined by wavelength λ, φₙ is phase, and the geometric parameters comprise r, s, and θ so that edge position X₀ can be determined with following formula
$${X}_{0} = \frac{\begin{matrix}{\sum }_{n = 1}^{N} \sqrt{{φ}_{n} - 0.25} {\sum }_{n = 1}^{N} ( \sqrt{{φ}_{n} - 0.25} {X}_{n} ) - \\ {\sum }_{n = 1}^{N} {X}_{n} {\sum }_{n = 1}^{N} ( {φ}_{n} - 0.25 )\end{matrix}}{{( {\sum }_{n = 1}^{N} \sqrt{{φ}_{n} - 0.25} )}^{2} - N {\sum }_{n = 1}^{N} ( {φ}_{n} - 0.25 )} .$$

21. A device for measuring an object comprising:
a projected laser beam light source; and
a light sensitive Fresnel-near field diffractive sensor structured to solve mathematical algorithms to measure an object based upon at least one sensed edge position of the object indicated from at least one sensed Fresnel-near field diffractive pattern which the object casts upon the sensor from the projected laser beam.

22. The device of claim 21 wherein the projected laser beam light source is a line-structured laser beam.

23. The device of claim 21 wherein the projected laser beam light source is a projected collimated laser beam light source.

24. The device of claim 21 wherein a plurality of edge positions are sensed within a single beam width of the projected laser beam light source.

25. The apparatus of claim 1 further comprising:
a spherical lens beam expander wherein the beam is propagated through the spherical lens beam expander;
a collimator lens wherein the beam is propagated through the collimator lens so that the beam is diffracted by at least one edge of the object and so that the beam forms a near field Fresnel diffraction fringe pattern upon multi-axis elements of the sensor for multi-axis measurement of the workpiece.

26. The method of claim 14 wherein the sensing is multi-axis sensing.
